(19) United States
(12) Patent Application Publication
(10) Pub. No.: US 2025/0147236 A1
(43) Pub. Date: May 8, 2025

(54) ARBITRARY POLARIZATION MODE GENERATOR BASED ON OPTICAL CHIP

(71) Applicant: SILITH TECHNOLOGY PTE. LTD., SINGAPORE (SG)

(72) Inventors: Yuxuan CHEN, Shanghai (CN); Ke ZHANG, Shanghai (CN)

(73) Assignee: SILITH TECHNOLOGY PTE. LTD., SINGAPORE (SG)

(21) Appl. No.: 18/920,964

(22) Filed: Oct. 20, 2024

(30) Foreign Application Priority Data
Oct. 25, 2023 (CN) 202311384746.2

(51) Int. Cl. G02B 6/126; G02B 6/124

(52) U.S. Cl. CPC G02B 6/126; G02B 6/124

(57) ABSTRACT

Discloses an arbitrary polarization mode generator based on a photonic integrated circuit, which includes a plurality of polarization structures arranged on the photonic integrated circuit and forming an array, each polarization structure in the array is configured to disassemble a polarization state in a target mode into the plurality of units correspondingly, and a polarization state of each unit after disassembly is independently completed by one of the polarization structure correspondingly, so that generating any required polarization state is realized. According to the disclosure, the polarization state of the non-uniformity mode in a polarization space is disassembled, and an independent polarization is generated by using the polarization structure, so as to generate any polarization mode including a vector mode can be realized by using on-chip design, having a plurality of advantages including low cost, good stability and high integration degree, and convenient for productization.

### CROSS-REFERENCE TO RELATED APPLICATION

This application claims the priority benefit of China application serial no. 202311384746.2, filed on Oct. 25, 2023. The entirety of the above-mentioned patent application is hereby incorporated by reference herein and made a part of this specification.

### BACKGROUND

### Technical Field

The present application relates to the technical field of optoelectronics, in particular to an arbitrary polarization mode generator based on a photonic integrated circuit.

### Description of Related Art

A polarization state of a vector mode has a character of spatial non-uniformity, the character enables the vector mode to be widely applied to a plurality of scenarios. In particular, a vector mode set has orthogonality, thus the vector mode set can be used as a plurality of transmission channels, enabling an ultra-high-capacity transmission. Currently the vector mode has achieved a kilometer-level DSP-free optical fiber transmission with low bit error rate. While a transmission application of the vector mode in a free-space optics (FSO) has also been widely discussed.

However, since the polarization state of the vector mode has a character of spatial non-uniformity, a generation process is complicated. For example, it requires a combination of a spatial light modulator (SLM) and a Q plate, or a digital micromirror device, with a series of optical devices in the FSO (objective lenses, lenses, etc.), to generate the vector mode.

A difficulty in generating a polarization vector mode in an FSO system in the prior art is that:
(1) an equipment currently used is expensive, which is not conducive to productization;
(2) a cascade of the optical devices in the FSO has a very high requirement for optical alignment, thus the generator has a poor stability;
(3) a plurality of optical devices in the FSO occupy too much space, an integration level of a generator is low, thus it is not acceptable in a practical application of an optical fiber communication.

### SUMMARY

An objective of the present application is providing an arbitrary polarization mode generator based on a photonic integrated circuit, in order to overcome a plurality of above-mentioned defects in the prior art.

In order to achieve the objective stated above, the technical solution of the present application is as follows:

The present application provides an arbitrary polarization mode generator based on a photonic integrated circuit chip, comprising:
a plurality of polarization structures, arranged on the photonic integrated circuit chip and forming an array, wherein each of the plurality of polarization structures in the array is configured to disassemble a polarization state in a target mode into a plurality of units correspondingly, so that a polarization state of each of the plurality of units after being disassembled is completed independently by one of the plurality of polarization structures correspondingly, so as to generate an arbitrary polarization state desired.

Further, each of the plurality of polarization structures comprises a polarizer, each of the plurality of polarizers has two input ends arranged, and by controlling a relative light intensity and a relative phase of an input light entering the two input ends, the polarizer is able to output an output light in an arbitrary polarization state independently.

Further, each of the plurality of polarizers comprises a two-dimensional grating, each of the plurality of polarizers forms the array through the two-dimensional grating thereof, and the array disassembles a vector mode polarization state into the plurality of units, each of the plurality of units has a linear polarization state in a different direction.

Further, each of the plurality of two-dimensional gratings has the two input ends arranged, by using a directional coupler and a phase shifter connected to each of the plurality of two-dimensional gratings to control the relative light intensity and the relative phase of the input light entering the two input ends of each of the plurality of two-dimensional gratings, the plurality of two-dimensional gratings are able to output the output light in the arbitrary polarization state. Further, each of the two input ends of each of the plurality of two-dimensional gratings is connected to one of the plurality of phase shifters respectively, the two of the plurality of phase shifters are connected to same one of the plurality of directional couplers, the plurality of directional couplers are connected to a light source, each of the plurality of directional couplers is configured to control a light splitting ratio of the input light input by the light source, so as to control the relative light intensity of the input light entering respectively the two input ends of each of the plurality of two-dimensional gratings; and the two of the plurality of phase shifters are configured to control the relative phases of the input light entering respectively the two input ends of each of the plurality of two-dimensional gratings, so that the plurality of two-dimensional grating are able to output the output light in the arbitrary polarization state.

Further, the two input ends of the plurality of two-dimensional gratings are corresponding respectively to a direction of an X-component and a direction of a Y-component, the direction of the X-component and the direction of the Y-component are perpendicular to each other in a space, while an output end of each of the plurality of two-dimensional gratings is corresponding to a direction of a Z-component in the space.

Further, the photonic integrated circuit chip comprises a substrate and a waveguide functional layer arranged on the substrate, the plurality of two-dimensional gratings, the plurality of directional couplers, and the plurality of phase shifters are arranged on the waveguide functional layer and are connected to each other through a waveguide, and the plurality of two-dimensional gratings output the output light in the arbitrary polarization state along a direction away from the substrate and a surface of the waveguide functional layer.

Further, a material of the waveguide functional layer comprises silicon, silicon nitride, or lithium niobate.

Further, a structure of each of the plurality of two-dimensional gratings is same or different; and/or a size of each of the plurality of two-dimensional gratings is same or different.

Further, each of the plurality of two-dimensional gratings is arranged in a circle before forming the array.

It can be seen from the technical solution stated above that, by disassembling the polarization state of the non-uniformity mode in a polarization space, and generating an independent polarization by each of the plurality of polarization structures (the plurality of polarizers), the present application is able to generate the arbitrary polarization mode including the vector mode. Further, by adopting the plurality of polarizers, each with one of the plurality of two-dimensional gratings on the photonic integrated circuit chip to form the array, before disassembling the polarization state in the target mode into a plurality of corresponding units, each of the plurality of polarizers has a capability of generating independently all polarization states, and by adopting the plurality of directional couplers and the plurality of phase shifters to control the relative intensity and the relative phase of the input light entering the two input ends of each of the plurality of two-dimensional gratings, the generator having the non-uniformity mode in the polarization space is realized by using an on-chip design. The present application can be based on a platform such as Silicon-On-Insulator (SOI), having a plurality of advantages including low cost, good stability and high integration level, while being conducive to productization.

### BRIEF DESCRIPTION OF THE DRAWINGS

FIG. 1 illustrates a schematic diagram on a polarization direction of a ring core optical fiber intrinsic vector mode TE₀₁ and TM₀₁;

FIG. 2 illustrates a schematic structural diagram on disassembling a vector mode polarization into a plurality of units by an array according to a preferred embodiment of the present application;

FIG. 3 illustrates a schematic structural diagram on controlling relative light intensity and phase input from two ends of a two-dimensional grating by using an adjustable directional coupler and two of the plurality of phase shifters according to a preferred embodiment of the present application.

### DESCRIPTION OF THE EMBODIMENTS

The present application provides an arbitrary polarization mode generator based on a photonic integrated circuit, comprising: a plurality of polarization structures arranged on the photonic integrated circuit and forming an array. Each of the plurality of polarization structures in the array is configured to disassemble a polarization state in a target mode into a plurality of corresponding units, so that a polarization state of each of the plurality of corresponding units after being disassembled is completed independently by one of the plurality of polarization structures correspondingly, so as to achieve generation of an arbitrary polarization mode desired.

By disassembling the polarization state of a non-uniformity mode in a polarization space, and generating an independent polarization by each of the plurality of polarization structures (a plurality of polarizers), the present application is able to generate the arbitrary polarization mode including a vector mode.

To make the objective, technical solutions and advantages of the present application clearer, the technical solutions in the embodiments of the present application will be clearly and completely described below. Apparently, the embodiments described are some rather than all of the embodiments of the present invention. All other embodiments obtained by those of ordinary skill in the art based on the embodiments of the present invention without creative efforts shall fall within the scope of protection of the present invention. The technical or scientific terms used herein shall have the usual meanings understood by those of ordinary skill in the art to which the present invention belongs, unless otherwise defined. The similar term such as “include or comprise” refers to that an element or item that appears before the term covers elements or items listed after the term and their equivalents, without excluding other elements or items.

The embodiments of the present application are further described in detail below with reference to the accompanying drawings of the present application.

The arbitrary polarization mode generator based on the photonic integrated circuit as disclosed by the present application is described in detail below by taking a vector mode as an example.

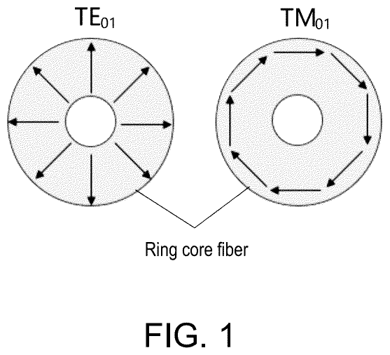

Referencing to FIG. 1, a polarization direction of a ring core optical fiber intrinsic vector mode TE₀₁ and TM₀₁ is showing as an arrow direction.

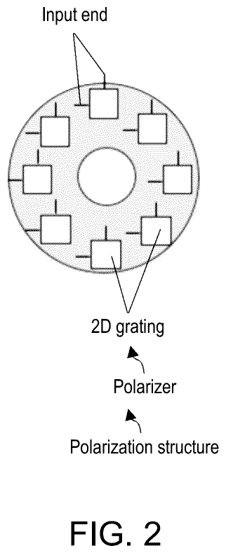

Referencing to FIG. 2, an arbitrary polarization mode generator based on a photonic integrated circuit as disclosed in the present application comprises a plurality of polarization structures arranged on a photonic integrated circuit and forming an array. For the non-uniformity in the polarization space of the vector mode, a manner of the array is adopted, and the polarization state in the target mode is disassembled into a plurality of corresponding units by each of the plurality of polarization structures in the array. In an embodiment, according to the vector mode shown in FIG. 1, the vector mode may be disassembled correspondingly into a plurality of units arranged along a circumference, while an amount of the plurality of units is corresponding to an amount of the plurality of polarization structures. After disassembly, the polarization state of each of the plurality of units is completed independently by one of the plurality of polarization structures correspondingly, so as to generate anyone desired polarization state.

In a plurality of embodiments, each of the plurality of polarization structures comprises a polarizer, and a plurality of polarizers are arranged circumferentially to form the array. In such a way, after disassembling the target mode polarization state, the polarization state of each of the plurality of units is completed by an independent polarizer. That is, the polarization state of the non-uniformity mode in the polarization space is disassembled, before each of the plurality of polarizers is configured to generate independent polarization for each of the plurality of units.

In a plurality of embodiments, All the plurality of polarizers in the array have an exactly same design, while each of the plurality of polarizers has an ability of independently producing all of the polarization states.

Alternatively, a specific design of each of the plurality of polarizers is not required to be completely the same, as long as a functionality can be satisfied.

For a specific mode, each of the plurality of polarizers does not have to generate all possible polarization states, as long as a target mode requirement is satisfied.

In a plurality of embodiments, each of the plurality of polarizers has two input ends arranged, by controlling a relative light intensity and phase of an input light entering the two input ends of each of the plurality of polarizers, each of the plurality of polarizer is able to output independently an output light in an arbitrary polarization mode.

In a plurality of embodiments, each of the plurality of polarizers comprises a two-dimensional grating. Each of the plurality of polarizers forms the array through the two-dimensional grating thereof, and the array disassembles a vector mode polarization state into a plurality of units, each of the plurality of units has a linear polarization state in a different direction.

Further, each of the plurality of two-dimensional gratings has two input ends arranged (corresponding to the two input ends of each of the plurality of polarizers), by controlling a relative light intensity and a phase of the input light entering the two input ends of each of the plurality of two-dimensional gratings, each of the plurality of two-dimensional gratings is able to output the output light in the arbitrary polarization state.

In a plurality of embodiments, each of the plurality of two-dimensional gratings is arranged to form the array in a circle, as shown in FIG. 2.

In a plurality of embodiments, each of the plurality of two-dimensional gratings is arranged to form a first-order or multi-order array.

In a plurality of embodiments, a structure of each of the plurality of two-dimensional gratings is same or different.

In a plurality of embodiments, a size of each of the plurality of two-dimensional gratings is same or different.

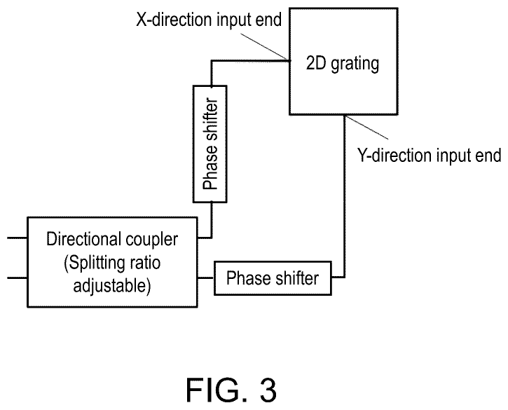

Referencing to FIG. 3 and FIG. 2, by adopting a plurality of directional couplers and a plurality of phase shifters to control the relative intensity and the relative phase of the input light entering the two input ends of each of the plurality of two-dimensional gratings, each of the plurality of two-dimensional gratings is able to output the output light in the arbitrary polarization state.

In a plurality of embodiments, a direction of each of the two input ends of each of the plurality of two-dimensional gratings is corresponding respectively to a direction of an X-component and a direction of a Y-component, the direction of the X-component and the direction of the Y-component are perpendicular to each other in a space, while a direction of an output end of each of the plurality of two-dimensional gratings is corresponding to a direction of a Z-component in the space. That is, each of the plurality of two-dimensional gratings has an input end in an X-direction and an input end in a Y-direction arranged, a direction of the input end in the X-direction is corresponding to the direction of the X-component and a direction of the input end in the Y-direction is corresponding to the direction of the Y-component respectively in the space, while the direction of the X-component and the direction of the Y-component are perpendicular to each other. A direction of the output end of each of the plurality of two-dimensional gratings is perpendicular to a paper surface and corresponding to the direction of the Z-component in the space. The input end in the X-direction and the input end in the Y-direction of each of the plurality of two-dimensional gratings, which are perpendicular to each other, are each connected to one end of one of the plurality of phase shifters, two other ends of the two phase shifters are connected to two output ends of a same one of the plurality of directional couplers respectively, while an input end of each of the of the plurality of directional couplers connects to a light source. A relative intensity and a relative phase of an X optical path and a Y optical path are controlled by using an on-chip design, so as to achieve a full adjustability.

Wherein a directional coupler having a light splitting ratio adjustable is configured to control the relative intensity of the X optical path and the Y optical path, and each of the plurality of phase shifters is configured to control the relative phases of the X optical path and the Y optical path. The directional coupler with the light splitting ratio adjustable, is able to control a light splitting ratio of the input light input from the light source, so as to control the relative light intensity of the input light entering the input end in the X-direction and the input end in the Y-direction of each of the plurality of two-dimensional gratings respectively, and two of the phase shifters are configured respectively to control the relative phases of the input light entering the two input ends of each of the plurality of two-dimensional gratings respectively, so that each of the plurality of two-dimensional gratings is able to output the output light in the arbitrary polarization state. Therefore, an arbitrary polarization mode generator based on a photonic integrated circuit as disclosed in the present application is implemented by using the on-chip design.

In a plurality of embodiments, the photonic integrated circuit comprises a substrate and a waveguide functional layer arranged on the substrate. The plurality of two-dimensional gratings, the plurality of directional couplers and the plurality of phase shifters are arranged on the waveguide functional layer and are connected to each other through a waveguide. Each of the plurality of two-dimensional gratings outputs the output light in the arbitrary polarization state in a direction (i.e. the Z-direction) pointing away from a surface of the substrate and the waveguide functional layer.

In a plurality of embodiments, a material of the waveguide functional layer comprises silicon, silicon nitride, or lithium niobate. Therefore, the present application can be designed based on a silicon optical platform or a lithium niobate platform, so as to implement the arbitrary polarization mode generator based on the photonic integrated circuit as disclosure in the present application.

All above, the present application, by disassembling the polarization state of the non-uniformity mode in the polarization space, and generating an independent polarization by each of the plurality of polarization structures (the plurality of polarizers), is able to generate the arbitrary polarization mode including the vector mode. Further, by adopting each of the plurality of polarizers having one of the plurality of two-dimensional gratings to form the array on the photonic integrated circuit, and disassembling the polarization state in the target mode into a plurality of units correspondingly, so that each of the plurality of polarizers has a capability of generating all polarization states independently, and by adopting the plurality of directional couplers and the plurality of phase shifters to control the relative intensity and the relative phase of the two input ends of each of the plurality of two-dimensional gratings, so that the arbitrary polarization mode generator is achieved by using the on-chip design. The present application is able to be based on a plurality of platforms including silicon light and more, having a plurality of advantages including low cost, good stability and high integration level, and facilitating productization.

Although the embodiments of the present application have been described in detail above, it is apparent to those skilled in the art that various modifications and variations can be made to these embodiments. However, it is to be understood that such modifications and variations are within the scope and spirit of the disclosure as described in the appended claims and embodiments. Furthermore, the present application described herein may have other embodiments and may be carried out or implemented in various ways.

What is claimed is:

1. An arbitrary polarization mode generator based on a photonic integrated circuit, comprising:
a plurality of polarization structures, arranged on the photonic integrated circuit and forming an array, wherein each of the plurality of polarization structures in the array is configured to disassemble a polarization state in a target mode into a plurality of units correspondingly, the plurality of units are arranged in a circle, and an amount of the plurality of units is corresponding to an amount of the plurality of polarization structures, so that a polarization state of each of the plurality of units after being disassembled is completed independently by one of the plurality of polarization structures correspondingly, so as to generate an arbitrary polarization state desired.

2. The arbitrary polarization mode generator according to claim 1, wherein each of the plurality of polarization structures comprises a polarizer, each of the plurality of polarizers has two input ends arranged, and by controlling a relative light intensity and a relative phase of an input light entering the two input ends, the polarizer is able to output an output light in the arbitrary polarization state independently.

3. The arbitrary polarization mode generator according to claim 2, wherein each of the plurality of polarizers comprises a two-dimensional grating, each of the plurality of polarizers forms the array through the two-dimensional grating thereof, and the array disassembles a polarization state in a vector mode into the plurality of units, each of the plurality of units has a linear polarization state in a different direction.

4. The arbitrary polarization mode generator according to claim 3, wherein each of the plurality of two-dimensional gratings has the two input ends arranged, by using a plurality of directional couplers and a plurality of phase shifters respectively connected to each of the plurality of two-dimensional gratings to control the relative light intensity and the relative phase of the input light entering the two input ends of each of the plurality of two-dimensional gratings, the plurality of two-dimensional gratings are able to output the output light in the arbitrary polarization state.

5. The arbitrary polarization mode generator according to claim 4, wherein each of the two input ends of each of the plurality of two-dimensional gratings is connected to one of the plurality of phase shifters respectively, two of the plurality of phase shifters connected to same one of the plurality of two-dimensional gratings are connected to same one of the plurality of directional couplers, the plurality of directional couplers are connected to a light source, each of the plurality of directional couplers is configured to control a light splitting ratio of the input light input by the light source, so as to control the relative light intensity of the input light entering respectively the two input ends of each of the plurality of two-dimensional gratings; and the two of the plurality of phase shifters are configured to control the relative phase of the input light entering respectively the two input ends of each of the plurality of two-dimensional gratings, so that the plurality of two-dimensional gratings are able to output the output light in the arbitrary polarization state.

6. The arbitrary polarization mode generator according to claim 4, wherein the two input ends of each of the plurality of two-dimensional gratings are corresponding respectively to a direction of an X-component and a direction of a Y-component, the direction of the X-component and the direction of the Y-component are perpendicular to each other in a space, while an output end of each of the plurality of two-dimensional gratings is corresponding to a direction of a Z-component in the space.

7. The arbitrary polarization mode generator according to claim 5, wherein the photonic integrated circuit comprises a substrate and a waveguide functional layer arranged on the substrate, the plurality of two-dimensional gratings, the plurality of directional couplers, and the plurality of phase shifters are arranged on the waveguide functional layer and are connected to each other through a waveguide, and the plurality of two-dimensional gratings output the output light in the arbitrary polarization state along a direction away from the substrate and a surface of the waveguide functional layer.

8. The arbitrary polarization mode generator according to claim 7, wherein a material of the waveguide functional layer comprises silicon, silicon nitride, or lithium niobate.

9. The arbitrary polarization mode generator according to claim 3, wherein a structure of each of the plurality of two-dimensional gratings is same or different; and/or a size of each of the plurality of two-dimensional gratings is same or different.

10. The arbitrary polarization mode generator according to claim 3, wherein each of the plurality of two-dimensional gratings is arranged in a circle before forming the array.
